(19) United States
(12) Patent Application Publication
(10) Pub. No.: US 2024/0028356 A1
(43) Pub. Date: Jan. 25, 2024

(54) CLOUD TRANSLATOR APPLICATION

(71) Applicant: SAP SE, Walldorf (DE)

(72) Inventors: Michail Vasiltschenko, Schriesheim (DE); Patrick Huy, NeuluBheim (DE); Maite Friedrich Dupont, Porto Alegre (BR)

(21) Appl. No.: 17/872,755

(22) Filed: Jul. 25, 2022

(51) Int. Cl. G06F 9/451; G06F 40/58; G06F 3/0482; G06F 3/04847

(52) U.S. Cl. CPC G06F 9/454; G06F 40/58; G06F 3/0482; G06F 3/04847

(57) ABSTRACT

Computer-readable media, methods, and systems are disclosed for translating a user interface from a source language to a target language in near real-time. Specifically, disclosed is a method for determining a plurality of user interface (UI) elements in a user interface of a web application, sending a request to translate the plurality of UI elements and receiving first values in the target language from the translation component, sending a request to retrieve at least one translation scenario and receiving second values in the target language from a central server, allowing a user to provide a third value for each of the plurality of UI elements, allowing the user to select the values for the plurality of UI elements, and rendering the user interface with the selected values for the plurality of UI elements.

### BACKGROUND

Many computer-implemented products must be distributed in multiple languages. For example, a web application is a client-server application in which a client (i.e., user interface) runs in a web browser. It is advantageous if the web application supports multiple language versions to enable usage by a larger audience.

In some instances, the translations of computer-implemented products are produced by professional human translators, which requires re-architecting the existing website backend and frontend technology to accommodate multiple languages. However, this option is time-consuming and costly. Another technique relies on pure machine translation; however, this lacks context and may have trouble with abbreviations, acronyms, diminutives, colloquial words/phrases, proper nouns, and/or common nouns.

### SUMMARY

Disclosed embodiments address the above-mentioned problems by providing one or more non-transitory computer-readable media storing computer-executable instructions that, when executed by a processor, perform a method for translating elements of a user interface in near real-time.

In some aspects, the techniques described herein relate to one or more non-transitory computer-readable media storing computer-executable instructions that, when executed by at least one processor, perform a method for translating a user interface, the method including determining a plurality of user interface (UI) elements in the user interface of a web application, wherein the plurality of UI elements has an original value, sending a request to a translation component to translate the plurality of UI elements from a source language to a target language, receiving a first value for each of the plurality of UI elements from the translation component, sending a request to a central server to retrieve at least one translation scenario, the at least one translation scenario including a second value for at least one of the plurality of UI elements, receiving the second value for the at least one of the plurality of UI elements from the central server, wherein the original value is in the source language and the first value and the second value are in the target language, allowing a user to provide a third value for each of the plurality of UI elements, allowing the user to select the original value, the first value, the second value, or the third value for the plurality of UI elements for display in the user interface, and rendering the user interface with the selected values for the plurality of UI elements.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is a system diagram illustrating an architecture to support a cloud translator application.

FIG. 2 is a flow diagram illustrating methods for translating a user interface using a cloud translator application consistent with various embodiments.

FIG. 3 is a flow diagram illustrating methods for translating a user interface using a cloud translator application consistent with various embodiments.

FIG. 4 is an exemplary user interface in a source language of English before translation.

FIG. 5 is an exemplary user interface after translation into a first target language.

FIG. 6 is an exemplary user interface after translation into a second target language.

FIG. 7 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

In order to demonstrate a web application to a user, it is preferable to show the user the application in the user's own language. However, acquiring a translation of an application for such a customized demonstration is costly and time-consuming. When an urgent request is made for a demonstration, no translation may be available in time. Additionally, when designing a user interface (UI) for an application, a primary language such as English text is frequently relied upon. Thus, upon translation to a different language the UI may become distorted. For example, there may not be enough space in the UI for the translated text. Therefore, a solution is necessary to provide a method for allowing a web application to be translated into a target language quickly and efficiently for use in development and demonstration purposes, as well as for use in the end product.

Translation is frequently based on a file-based word mapping, by using “key value pairs”. Typically, the same key will be used for the same values across many different files. Thus, there may be a database table that includes a word or phrase and a corresponding translation of that word or phrase. However, this type of translation lacks context, as it is only looking at a single word or phrase and not how the word or phrase is used. For example, “complete” could be used on a clickable button or a readable text and could be used as a noun or a verb. Additionally, if an exact text is not found in the translation file, it may be skipped completely, and the final translation will be incomplete.

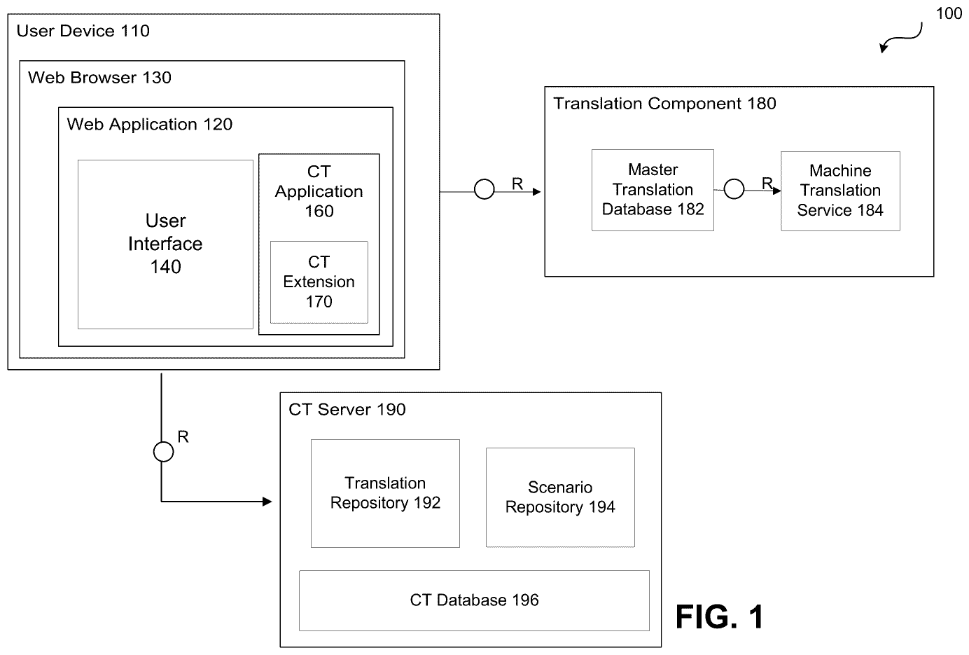

FIG. 1 is a block diagram of computing environment 100 for customizable translation of user interfaces of a web application, according to an embodiment. The computing environment 100 may include one or more client/user/computing devices (e.g., user device 110) configured to execute one or more web applications 120. Examples of the user device 110 may include, but are not limited to a desktop computer, a laptop computer, a tablet computer, or a mobile phone.

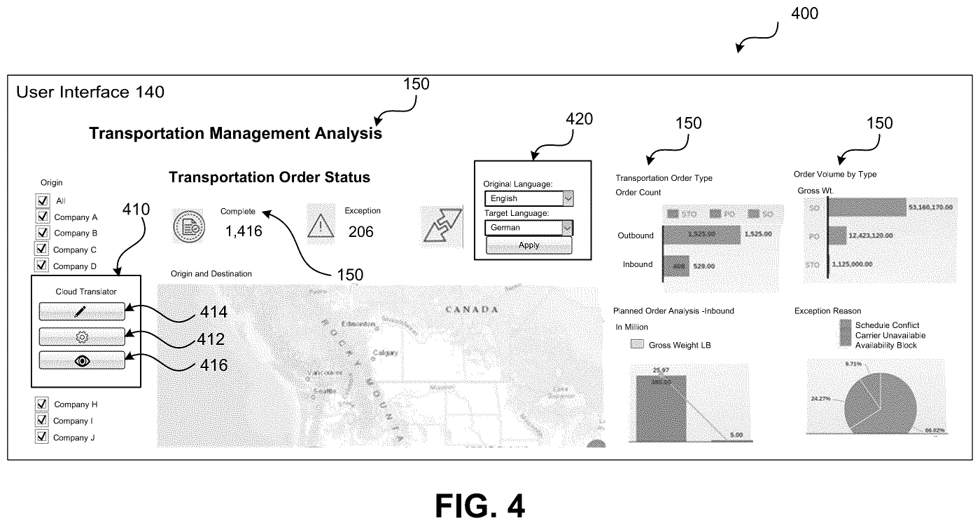

The web application 120 is a software application executable by a web browser 130 at the user device 110. The web application 120 can be coded in a browser-supported programming language, such as JavaScript®. The web application 120 can also be associated with a browser-rendered markup language, such as hypertext markup language (HTML). Further, the web application 120 may include one or more user interfaces 140 or website screens accessible via the web browser 130 by a user over the Internet. Exemplary user interfaces 400, 500, and 600 are shown in FIGS. 4-6. The user interface 140 may refer to an interactive area of the web application 120 where content is displayed and/or input is received. The user interface 140 may include user interface (UI) elements 150 such as, but not limited to, text segments, image files, audio clips, video clips, files, 3D graphics or any combination thereof. In some embodiments, the UI elements 150 comprise a translatable word, plurality of words, or a phrase. The web browser 130 may also include a cloud translator (CT) application 160 installed on web browser 130 through a browser extension 170.

A developer may use a source natural language (e.g., English, French, German, Chinese, Russian, Spanish, Polish, or other natural language) to develop the user interfaces 140 of the web application 120. Users of different natural languages, however, may be unable to effectively utilize the web application 120 unless the user interface 140 is translated to their natural language. Thereby, the user device 110 can be configured to communicate with cloud-based translation component 180 and/or CT server 190 via a communication network. The communication network can include a wide area network (WAN). e.g., the Internet.

The translation component 180 translates the user interfaces 140 of the web application 120. Providers of such components include, but are not limited to SAP® (e.g., SAP translation hub), Yandex®, Google®, or Bing®. In some embodiments, the translation component 180 includes a master translation database 182. In some embodiments, master translation database 182 may be created and maintained by the developer of the web application 120. In some embodiments, master translation database 182 may include translations (or replacement texts) for a plurality of UI elements. In some embodiments, the translation component 180 additionally or alternatively includes a machine translation service 184. However, the translation component 180 receives no feedback or interaction from a user.

In an embodiment, to supplement and improve the translations provided by the translation component 180, the computing environment 100 may include CT server 190. In an embodiment, the CT server 190 may include translation repository 192 and scenario repository 194. Translation repository 192 may store multiple translations of user interfaces 140 of web application 120. Scenario repository 194 may store the scenario data and/or sharing preferences associated with different users, different businesses, and different domains. The CT server 190 may also include a CT database 196 for storing and compiling the data from the translation repository 192 and the scenario repository 194. Further, the CT server 190 may be deployed on a cloud. Translation services could be used not only at a client site (e.g., browser JavaScript® library), but also on a server site of the web application allowing faster access to translation. In some embodiments, CT server 190 may make requests directly to the translation component 180. In some embodiments, the web browser 130 may not need to be connected to translation component 180 and may only connect to CT server 190, which includes translation repository 192.

In some embodiments, upon translation, the user may be allowed to revise the translation and/or provide feedback on the translation. Further, the feedback may be considered for updating the translations. Hence, the instant translation may provide better or high rated translations for the user interface elements and thus the user interfaces. By combining the user feedback/interaction with the cloud translation services, the quality of the translation can be improved. Also, costs are decreased by eliminating the need to translate user interfaces of web applications into a plurality of different languages at a software code level. In some embodiments, every user can create a customized version of a UI, such as a skin, in any supported language.

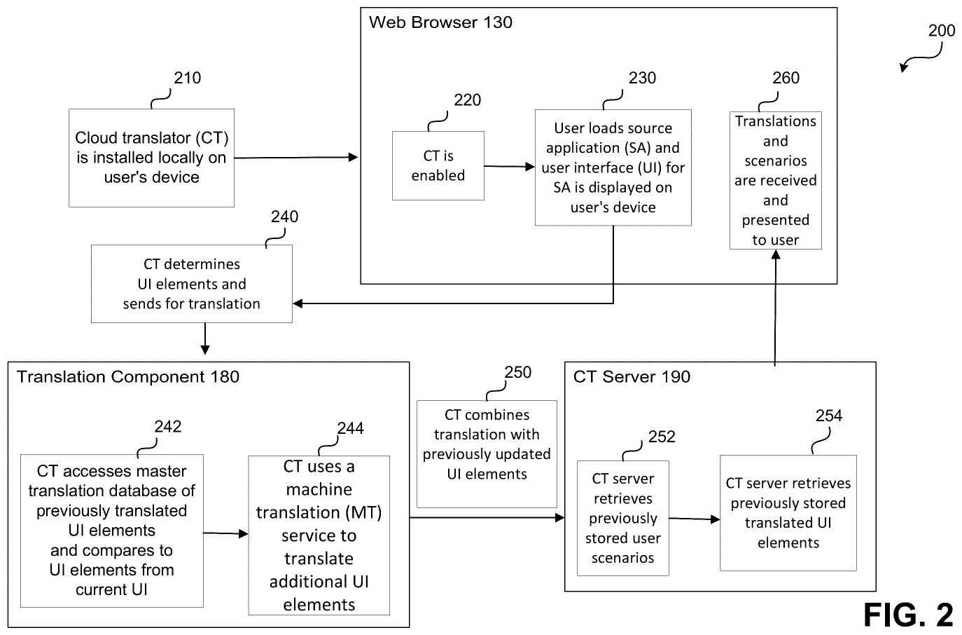

FIG. 2 is a flow diagram illustrating an example process 200 to provide customizable instant translation of user interfaces of a web application, according to an embodiment. At step 210, a cloud translator application 160 is installed locally on user device 110. In some embodiments, step 210 may include installing the cloud translator (CT) application 160 on web browser 130 through a browser extension 170 and activating the extension. At step 220, a user opens web browser 130 on their local device 110 and loads, enables, or turns on the CT application 160 that has been previously locally installed. At step 230, the user loads a web application 120, which may be any external application that is configured for use with the cloud translator application 160. In some embodiments, the user device 110 may include a whitelist of numerous web applications 120 that have been previously approved. If the web application 120 is included on a whitelist, the cloud translator application extension 170 will be automatically loaded. A control panel will be displayed on the cloud application screen, or in some embodiments, the control panel may be hidden if previously configured by the user to be hidden.

At 240, a request is generated to translate a user interface 140 of the web application 120 from a source language to a target language. The CT application 160 gathers all UI elements to be translated in the UI and sends to translation component 180 for translation thereof. For example, the request may be generated by software associated with web browser 130 executing on a user device 110. The request may be generated in response to loading the user interface 140 associated with the web application 120. In one example, the request is a hypertext markup language (HTML) request that includes information, for example, metadata, indicative of the natural language (e.g., the source language) associated with the request.

In some embodiments, at step 240, multiple user interface elements 150 (such as text segments) associated with the user interface 140 of the web application 120 are determined. In an embodiment, user interface elements 150 may be defined at least by a developer while developing the web application 120 or by a user of the web application. For example, during development of the web application 120, developer or designer may select the user interface elements or regions or controls of the web application where translations can be or cannot be performed (e.g., using HTML tags, scripts, and the like). Further, the developer may provide translation identifiers (e.g., via HTML attributes) for the user interface elements that should be translated. Also, a user may select the user interface elements of web application 120 for which translations can or cannot be performed directly on the running web application 120 in the browser 130. The user interface elements 150 can be, but are not limited to, text segments or SVG images with text parts User interfaces 140 may include different types of user interface elements 150, referred as text types. For example, the text type can be, but not limited to a message, a button, a column header, a table, and a pull-down menu.

In some embodiments, the CT application 160 contains personalization configurations. Upon the first use or initialization of the cloud translator application 160, a user must provide credentials for access to the system. Additionally, a source language and a target language are selected by the user. In some embodiments, the source language may be the same as the target language if a translation was already available or only gaps needed to be filled or master data updated. A default target language and default source language may be set by a user, such as in a user profile.

At step 240, the CT application 160 gathers all the UI elements in the user interface 140 (UI) to be translated for the particular web application 120 and sends them to translation component 180. In some embodiments, sending UI elements 150 for translation includes a first step 242 and a second step 244. Step 242 uses a database of previously translated UI elements 150, which may include professionally translated UI elements for the UI. Step 244 uses a machine translation service to cause generation of a new translation of any remaining UI elements 150 not found in step 242. In some embodiments, step 240 may be eliminated, and the process may skip to step 252.

At step 250, the machine translation acquired from steps 242 and 244 is combined with UI elements that were previously updated by the user and are displayed for the user to choose from. Specifically at step 252, the CT server 190 loads the user scenarios configurations and preferences. In some embodiments, this includes a list of available previously created scenarios shared with this user. At step 254, the CT server 190 loads previously stored translated UI elements 150. A user can choose to create a new scenario, use an existing scenario, or update an existing scenario. If a user makes changes to the translations of UI element 150, the changes are automatically saved locally in the user's local browser 130. In some embodiments, a sharing option enables the user to make the set of texts (a new scenario) available to other users. In some embodiments, a user may directly share their scenario with another user. In some embodiments, a user can share their scenario via download of the configurations into a file, which can be provided (via email, pendrive, etc.). In some embodiments, a user can share their scenario via upload of the configurations to the CT server 190, from where the configurations can be fetched as described above at step 252. The combination of both options provides maximum flexibility and personalization.

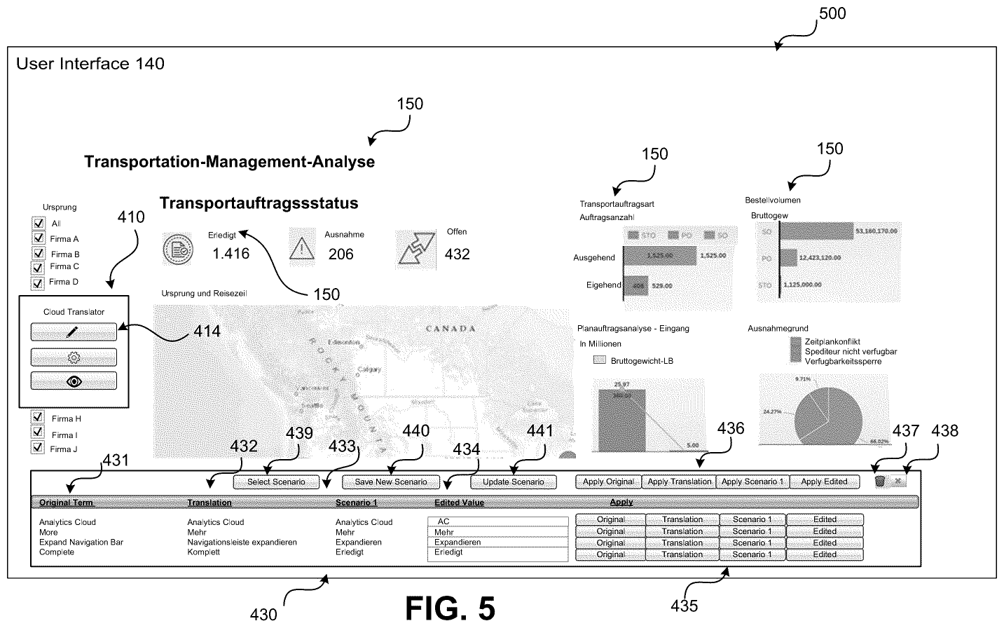

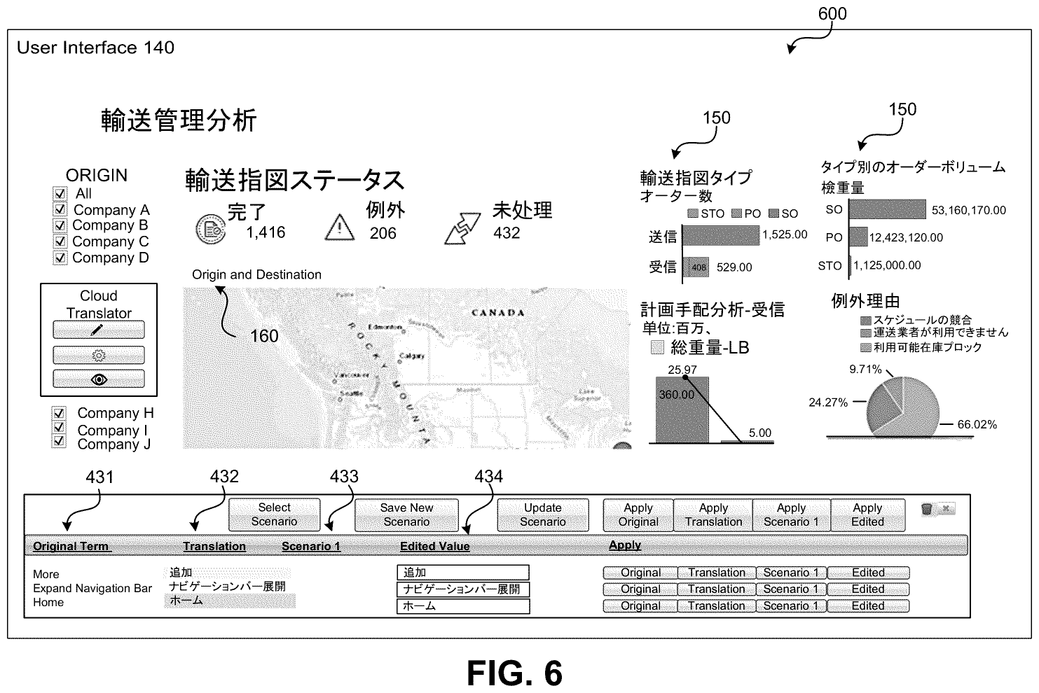

At step 260, the translations and scenarios are received and presented to the user. The translated user interface elements 150 are then rendered in the user interface 140 of the web application 120, as seen in exemplary FIGS. 5 and 6. The rendered user interface 140, 500, 600 may include translated user interface elements 150 and untranslated user interface elements. Upon translation, the translations are stored in a translation repository 192 in the cloud to enable instant translation of the user interfaces 140 in the future, for example.

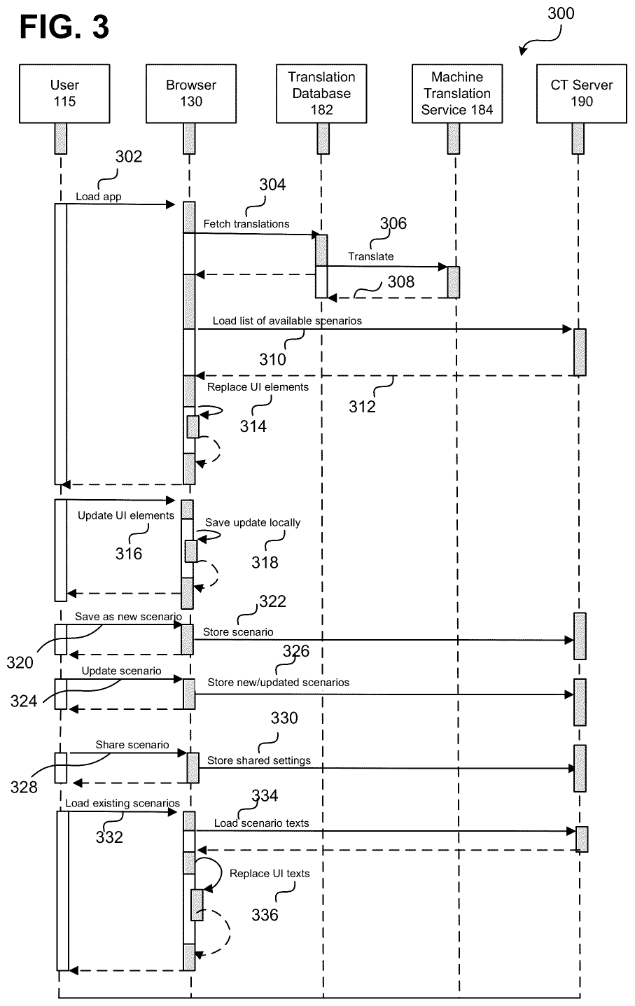

FIG. 3 illustrates an embodiment of the process 300 using cloud translator application 160. At step 302, a user 115 loads the cloud translation application 160 on web browser 130. At step 304, the browser 130 sends a request to translation database 182 to fetch translations for UI elements 150. At step 306, translation database 182 sends a request to machine translation service 184 to translate additional UI elements 150 that were not initially found in the translation database 182. At step 308, the values for the additional translations are returned from machine translation service 184 via translation database 182 to CT application 160 on browser 130 on user device 110. In some embodiments, the values for the additional translations done by machine translation service 184 are also saved in translation database 182. Thus, each use of the CT application 160 may improve the translation database 182 and save time in the future.

At step 310, the browser 130 sends a request to the CT server to load a list of available scenarios for the particular UI 140. A scenario may include a value for each of a plurality of UI elements 150 that has been previously customized by this user 115 or another user. At step 312, the list of available scenarios is returned to browser 130 and browser 130 provides user 115 with a list of scenarios from which to choose from. At step 314 once a scenario is selected, some or all the values for UI elements 150 can be replaced by the chosen scenario. User 115 can then view the updated UI elements 150 in the browser 130. At step 316, user 115 is given the opportunity to update the values for the UI elements 150 and modify the translations, as will be described further with respect to FIG. 5. At step 318, the updated values for UI elements 150 are stored locally on the user device 110 and can be viewed by user 115 on the user device 110. At step 320, user 115 can save the updated values as a new scenario locally on the user device 110. At step 322, the new scenario is stored centrally on the CT server 190, which will allow other users to access this new scenario. At step 324, user 115 can further update the scenario, store this updated scenario locally, and view this updated scenario on the browser 130. At step 326, the updated scenario can be stored centrally on the CT server 190. At step 328, the user can select a scenario that they have modified or created to share with other users. At step 330, the sharing configurations/scenarios created by the user 115 are stored in CT server 190. At step 332, user 115 can load a list of existing scenarios and choose a particular scenario to view on the browser 130. At step 334, the user device 110 via browser 130 can send a request to the CT server 190 to load the plurality of texts stored in CT server 190 for a given scenario and the user device 110 can receive the plurality of texts. At step 336, browser 130 replaces all UI elements 150 and modifies the texts to match the plurality of texts received from CT server for the current application 120 and thereby view a customized translation of the UI.

In an embodiment, a developer may use the CT application 160 to check how the web application 120 would be appear in multiple languages during development of the application 120. This allows the developer to modify the properties, such as the size, shape, font, etc. of the UI element 150 or provide more space when necessary for a target language UI element that may be longer or larger than the source language UI element.

An embodiment creates a translation “on the fly” or in near real-time. This allows a user to demonstrate a web application 120 that is originally in one language, for example English, in a translated form, such as in German, in a short amount of time. In an embodiment, the initial translation is done using translation component 180. The process then allows a user to edit the translations provided. For example, a user may edit entries on a table, such as shown in translation table 430 of FIG. 5. When the user edits an entry for a word or phrase, the translation of this exact entry is modified everywhere it appears in the UI 140. However, a similar but different word or phrase is not changed. The translation table 430 of edited translations and/or the data therein may be saved locally on the user device 110. In some embodiments, the edited translations may also be saved in a cloud server, such as CT server 190, such that multiple users can access this edited translation table 430 and/or the data therein. The CT server 190 stores the edited translations in translation repository 192. Therefore, additional users can now access this same edited translation. Previously, an edited translation could only be saved locally, and would disappear when the browser cache was cleared. A central cloud depository, such as CT server 190, allows for the corrections made by one user to be accessible by other users. The translations can be disassociated from the software delivery itself, allowing for the delivery of new translations at any time.

FIG. 4 shows an exemplary user interface 400 having multiple user interface elements 150. The cloud translator application 160 provides a window 410, which may be a pop-up window, for allowing a user to translate the user interface 400 in the web application 120. Window 410 may include clickable buttons, such as settings button 412, edit button 414, and view button 416. The view button 416 allows the user to control hiding CT-related UI elements from view during ordinary usage of the web application 120. When the user clicks on the settings button 412, a language window 420 will appear, which may be a pop-up window. The user can select a source language as the “Original Language,” such as English, such as from a drop-down menu. The user can also select a “Target Language,” such as German or Japanese, such as from another drop-down menu. The user then clicks an entry button, such as “Apply”, and the translation step 240 occurs (and the language window 420 may automatically be closed). In near real-time, a translation of UI elements 150 is provided to the user.

An exemplary translation 500 of the user interface 140 in German is shown in FIG. 5, which would result after the user clicks “Apply”. The CT application 160 sends a request to the translation component 180 and to the CT server 190 and receives values for each of the UI elements 150. For example, the user interface 400 may include the UI element “Transportation Order Type” in English as seen in FIG. 4. In translated user interface 500, the UI element “Transportation Order Type” may be replaced by “Transportauftragsart” in German as seen in FIG. 5. As another example, the UI element “Complete” in FIG. 4 may be replaced by UI element “Erledigt” in FIG. 5.

In some embodiments, by default, the UI elements 150 may initially be replaced by the translation from translation component 180. However, the initial translation may potentially have errors or may not have the desired equivalents for all the UI elements 150 as the user wants to view them. The CT application 160 further allows the user to edit selected UI elements 150. When the user clicks on the edit button 414 in window 410, translation table 430 appears. In some embodiments, translation table 430 may be provided at the bottom of the screen, as shown in FIG. 5, however the translation table 430 may be shown anywhere on the UI.

As shown in FIG. 5, translation table 430 includes a row for each user interface (UI) element 150. In some embodiments, translation table 430 includes the following columns: original term column 431, translation column 432, scenario column 433, and edited value column 434. Additional or fewer columns may be provided to allow for more flexibility, and the user may be allowed to choose which columns to view in translation table 430. For example, original term column 431 lists each word or phrase corresponding to each UI element 150 as it appeared in the source language. Translation column 432 lists the translation of each word or phrase corresponding to each UI element 150 as retrieved from the translation component 180 (which includes the translations from the master translation database 182 and from machine translation service 184).

The scenario column 433 lists the corresponding term for each UI element 150 as retrieved from the CT server 190. In some embodiments, the values provided in scenario column 433 can include values received from any of translation repository 192, scenario repository 194, and CT database 196. In some embodiments, multiple scenario columns may be provided. In some embodiments, a user must choose all or none of the values for a particular scenario. In some embodiments, different columns can be provided for allowing the user to choose values from each of the translation repository 192, the scenario repository 194, or the CT database 196. Multiple combinations and configurations are contemplated, allowing for the user to choose from a number of values that have been provided by the current user or by a different user. In some embodiments, scenario column 433 may not be included. In some embodiments, additional buttons can be provided to allow a user to select a scenario, save a new scenario, or update a scenario.

In some embodiments, buttons may be provided on translation table 430 to allow selection of a scenario, as shown in FIG. 5. In some embodiments, the list of scenarios for the displayed UI elements 150 that are visible to the user may be fetched and displayed to the user. In some embodiments, the user may select a preexisting scenario stored in CT server 190 to prefill the UI 140 (such as by clicking Select Scenario button 439). In some embodiments, a separate window or table can be provided for the user to select a scenario. In some embodiments, the user may also need to select the specific version of the scenario to load from CT server 190.

For example, a separate setting may allow for the user to select Scenario 1 for replacing all UI elements 150. After selecting Scenario 1, a user may then open the translation table 430 and edit particular UI elements with respect to the Scenario 1. In some embodiments, when a user selects Scenario 1, the default values shown in the edited value column 434 may be the values of Scenario 1. In some embodiments, the user can save a newly edited version of the UI as Scenario 2, locally and/or centrally.

In some embodiments, users can consolidate the set of texts they see in the UI into a scenario saved in CT server 190 (such as by clicking the Save New Scenario button 440), thereby generating a new version of the scenario. In some embodiments, after selecting a scenario, the user may change the scenario as desired and update the scenario in CT server 190, without generating a new version (such as by clicking the Update Scenario button 441).

Edited value column 434 provides an editable field, such as a form-fillable field into which a user can provide an alternative replacement for the UI element 150. Table 430 also includes buttons 435 to allow the user to choose which value to display in the UI for each UI element 150. Buttons 435 may include: original, translation, scenario #, or edited. In some embodiments, additional buttons 436 at the top of the columns allow a user to select all, such as to apply original, apply translation, apply scenario #, or apply edited to all of the UI elements 150. A trash icon 437 allows user to delete the edited values locally and reset but does not change anything in the scenarios stored in the CT server 190 or CT database 196. A close icon 438 allows a user to close the window showing table 430. In some embodiments, additional settings may be provided to allow the user to view multiple scenarios and choose one or more scenarios to view in the translation table 430.

In some embodiments, the editable field in edited value column 434 is initially filled in with the value from the translation column 432. However, a user can type anything, including symbols and icons in some embodiments, into the edited value column 434 for a UI element 150, thus allowing for personal customization of the UI. For example, the user could change the UI element 150 for “Analytics Cloud” to an abbreviation “AC” by typing in the edited value box in that row and clicking on the apply “edited” button. As another example, the user could change the UI for “Expand Navigation Bar” to “Expandieren” to shorten the initially provided translation. Additionally, a user could change the translation of “Complete” to take into account the context of the UI element 150. Although one possible translation of “Complete” may be “Komplett,” a better replacement in this context may be “Erledigt,” which means “Done.” In a previous scenario, this user or another user determined that “Erledigt” was a better translation for this particular usage of “Complete” and this was saved in Scenario 1. Thus, the translation by the CT application 160 here takes into account the context of the UI element by using prior scenarios from CT server 190.

When an entry for a particular UI element 150 is changed in edited value column 434, and the edited button 435 is selected, that particular term will be changed everywhere that same exact phrase appears on the UI. For example, “Expand Navigation Bar” will be changed to “Expandieren” Thus, when a user sees an improper translation or wants to customize a term, they can do so immediately. However, a similar term, which may include some but not all the words of the UI element, will not be changed. Thus, if the word “Expand” appeared elsewhere in the UI, this would not be changed.

An exemplary translation 600 of the user interface 140 in Japanese is shown in FIG. 6, which would result after the user clicks “Apply” in the language window 420. As seen in FIG. 6, not all UI elements are translated initially. A user can enter a translation for any missing UI elements 150 to fill in the translation gap. In this example, no scenarios are currently saved (column 433 is blank) for this user interface 140 in Japanese. However, once a user modifies the current interface, they can save this as a new scenario locally and also send this to the central CT server 190 to save for access by other users.

In some embodiments, a user can create one or more scenarios for each user interface 140. A web application 120 may have multiple user interfaces 140, which can each be translated and edited by using CT application 160. A user may create a personal profile in the CT application 160. A user's profile may include security settings, which may include a user role such as standard, expert, power user, administrator, or professional translator. Depending on an assigned role, the user may be granted particular access to retrieve, modify, and save the scenarios, both locally and centrally. In some embodiments, one scenario may be official external translation as maintained by a provider of the web application 120. In some embodiments, a scenario may be a personal customized translation. In some embodiments, a scenario may be specific to a user group or a department.

In some embodiments, the UI itself may be customized locally to include UI elements 150 that are different from the original version of the web application 120. CT application 160 allows for the customized UI elements 150 to be edited in the same way that original UI elements 150 may be edited.

In some embodiments, a conflict management system may be included, such as a versioning system. In some embodiments, when web application 120 is updated, the translation and customization will be reset. In some embodiments, a user may choose not to install an update of the application 120 to preserve the custom translations. In some embodiments, a partial update may be installed as selected by a user.

In some embodiments, CT server 190 includes an analytics component that can analyze the scenarios and translations that have been changed. In some embodiments, the analytics component may include a machine learning element, such that the analytics component may be improved based on additional data. In some embodiments, if analytics component determines that the same UI element 150 has been changed by a majority of users to the same replacement value, this replacement value may be used to supersede any other values for that particular UI element. In such a way, crowdsourcing can be used to improve the translations in CT database 196.

In some embodiments, the analytics component can extract the UI elements and the replacement values from multiple saved scenarios and compile them in a database. By comparing the replacement values from multiple scenarios and multiple users, the analytics component may use machine learning to determine the best replacement values for each UI element. In some embodiments, the analytics component may create a master scenario using the best replacement values. The best replacement values may be determined based on a number of parameters, such as the number of users who selected this replacement value, the rating of the users who selected this replacement value, and the role of the users who selected this replacement value. A rating may be based on how many edits a user has performed or how many scenarios a user has saved and/or shared. A role may be set by the user or by an administrator and may be defined by the expertise of the user, such as a certified translator, a power user, or a standard user.

In some embodiments, a user can select different saving options, including locally, centrally, or both. In some embodiments, a user can save in such as way so to restrict the access of who can view and/or edit the user's saved scenarios and/or particular elements of the saved scenarios. Such restricted access can be based on a user's role and/or the role of a user who is requesting access. A user may save multiple scenarios for the same UI, such as scenarios personalized to a particular company, an industry, or a particular individual. In some embodiments, there may be multiple scenarios for the same UI created by different users. In some embodiments, not all scenarios available for one UI are displayed or available to all users.

In some embodiments, by saving a scenario in a central location, such as the CT server 190, one user, such as an expert, can correct/improve a translation and all other users can access this. Thus, each user will not need to translate and make the same changes to the UI. In some embodiments, some users may only be allowed to retrieve translations, while other users may be allowed to save, edit and/or retrieve the translations. In some embodiments, there may be multiple repositories where different scenarios may be saved, such as classified by a particular group of users (company) or a particular industry. In some embodiments, there may be a separate repository for the official translation provided by the web application developer.

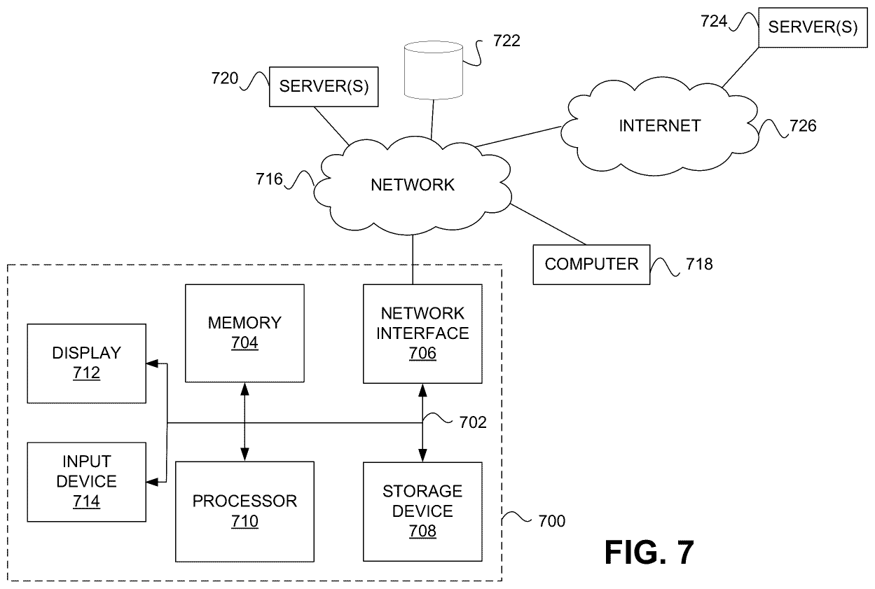

FIG. 7 is a diagram illustrating a sample computing device architecture for implementing various aspects described herein. Computer 700, such as user device 110, can be a desktop computer, a laptop computer, a server computer, a mobile device such as a smartphone or tablet, or any other form factor of general- or special-purpose computing device containing at least one processor. Depicted with computer 700 are several components, for illustrative purposes. Certain components may be arranged differently or be absent. Additional components may also be present. Included in computer 700 is system bus 702, via which other components of computer 700 can communicate with each other. In certain embodiments, there may be multiple busses or components may communicate with each other directly. Connected to system bus 702 is at least one processor 710. Also attached to system bus 702 is memory 704. Also attached to system bus 702 is display 712. In some embodiments, a graphics card providing an input to display 712 may not be a physically separate card, but rather may be integrated into a motherboard or processor 710. The graphics card may have a separate graphics-processing unit (GPU), which can be used for graphics processing or for general purpose computing (GPGPU). The graphics card may contain GPU memory. In some embodiments no display is present, while in others it is integrated into computer 700. Similarly, peripherals such as input device 714 is connected to system bus 702. Like display 712, these peripherals may be integrated into computer 700 or absent. Also connected to system bus 702 is storage device 708, which may be any form of computer-readable media, such as non-transitory computer readable media, and may be internally installed in computer 700 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface 706 is also attached to system bus 702 and allows computer 700 to communicate over a network such as network 716. Network interface 706 can be any form of network interface known in the art, such as Ethernet, ATM, fiber, Bluetooth, or Wi-Fi (i.e., the Institute of Electrical and Electronics Engineers (IEEE) 802.11 family of standards). Network interface 706 connects computer 700 to network 716, which may also include one or more other computers, such as computer 718, and network storage, such as cloud network storage. Network 716 is in turn connected to public Internet 726, which connects many networks globally. In some embodiments, computer 700 can itself be directly connected to public Internet 726. Network 716 may be connected to one or more servers 720, 724, either directly or via Internet 726, such as CT server 190. Network 716 may also be connected to a cloud storage device 722, such as a database.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope of the disclosure as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The following detailed description of embodiments references the accompanying drawings that illustrate specific embodiments in which the present teachings can be practiced. The described embodiments are intended to illustrate aspects of the disclosure in sufficient detail to enable those skilled in the art to practice the present teachings. Other embodiments can be utilized, and changes can be made without departing from the claimed scope of the present teachings. The following detailed description is, therefore, not to be taken in a limiting sense. The scope of embodiments is defined only by the appended claims, along with the full scope of equivalents to which such claims are entitled.

Having thus described various embodiments, what is claimed as new and desired to be protected by Letters Patent includes the following:

1. One or more non-transitory computer-readable media storing computer-executable instructions that, when executed by at least one processor, perform a method for translating a user interface, the method comprising:
identifying a plurality of user interface (UI) elements in the user interface of a web application, wherein the plurality of UI elements has an original value;
providing a request to a translation component to translate the plurality of UI elements from a source language to a target language;
receiving a first value for each of the plurality of UI elements from the translation component, wherein the first value includes one or more acronyms, abbreviations, words, phrases, or terms in the target language;
providing a request to a central server to retrieve at least one translation scenario, said at least one translation scenario comprising a second value for at least one of the plurality of UI elements, wherein the second value includes one or more acronyms, abbreviations, words, phrases, or terms in the target language;
receiving the second value for the at least one of the plurality of UI elements from the central server, wherein the second value is a previously customized value,
wherein the original value is in the source language and the first value and the second value are in the target language;
allowing a user to provide a third alternative value for each of the plurality of UI elements, wherein the third alternative value includes one or more acronyms, abbreviations, words, phrases, or terms in the target language, wherein providing the third alternative value further comprises typing into a form fillable field, into which the user can type text, symbols, or icons of the third alternative value;
allowing the user to independently select the original value, the first value, the second value, or the third value for each of the plurality of UI elements for display in the user interface; and
rendering the user interface with the selected values for each of the plurality of UI elements.

2. (canceled)

3. The non-transitory computer-readable media of claim 1, wherein the translation component comprises a master translation database and a machine translation service, and wherein providing the request to the translation component comprises:
providing a first request to the master translation database and providing a second request to the machine translation service.

4. The non-transitory computer-readable media of claim 3, wherein the first request provides the first value for at least one UI element in the plurality of UI elements, and wherein the second request provides the first value for at least one remaining UI element in the plurality of UI elements.

5. The non-transitory computer-readable media of claim 1, further comprising:
storing a selected combination of the original values, the first values, the second values and the third values as a first custom user scenario.

6. The non-transitory computer-readable media of claim 5, wherein the first custom user scenario is stored on the central server for access by a plurality of users.

7. The non-transitory computer-readable media of claim 5, further comprising:
sharing the first custom user scenario with other users by sending to the central server.

8. The non-transitory computer-readable media of claim 1, wherein the at least one translation scenario comprises a plurality of translation scenarios, further comprising allowing the user to select one or more of the plurality of translation scenarios for viewing in a translation table.

9. A computing system to provide near real-time translation of a user interface of a web application on a user device, comprising:
at least one processor; and
at least one non-transitory machine-readable medium storing computer executable instructions that when executed by the at least one processor cause the system to:
identify a plurality of user interface (UI) elements in a user interface of a web application, wherein the plurality of UI elements has an original value;
send a request to a translation component to translate the plurality of UI elements from a source language to a target language;
receive a first value for each of the plurality of UI elements from the translation component, wherein the first value includes one or more acronyms, abbreviations, words, phrases, or terms in the target language;
send a request to a central server to retrieve at least one translation scenario, said at least one translation scenario comprising a second value for at least one of the plurality of UI elements, wherein the second value includes one or more acronyms, abbreviations, words, phrases, or terms in the target language;
receive the second value for the at least one of the plurality of UI elements from the central server, wherein the second value is a previously customized value,
wherein the original value is in the source language and the first value and the second value are in the target language;
allow a user to provide a third alternative value for each of the plurality of UI elements, wherein the third alternative value includes one or more acronyms, abbreviations, words, phrases, or terms in the target language, wherein providing the third alternative value further comprises typing into a form fillable field, into which the user can type text, symbols, or icons of the third alternative value;
allow the user to independently select the original value, the first value, the second value, or the third value for each of the plurality of UI elements for display in the user interface; and
render the user interface with the selected values for each of the plurality of UI elements.

10. The system of claim 9, wherein the translation component comprises a master translation database and a machine translation service, and wherein causing the system to send the request to the translation component comprises:
sending a first request to the master translation database and sending a second request to the machine translation service.

11. The system of claim 10, wherein the first request provides the first value for at least one UI element in the plurality of UI elements, and wherein the second request provides the first value for at least one remaining UI element in the plurality of UI elements.

12. The system of claim 9, further causing the system to:
store a selected combination of the original values, the first values, the second values and the third values as a first custom user scenario on the central server for access by multiple users.

13. The system of claim 9, further causing the system to:
store a selected combination of the original values, the first values, the second values and the third values as a first custom user scenario locally on the user device.

14. The system of claim 9, wherein the at least one translation scenario comprises a plurality of translation scenarios, further causing the system to:
allow the user to select one or more of the plurality of translation scenarios for viewing in a translation table.

15. A method for translating a user interface, the method comprising:
identifying a plurality of user interface (UI) elements in a user interface of a web application, wherein the plurality of UI elements has an original value;
providing a request to a translation component to translate the plurality of UI elements from a source language to a target language;
receiving a first value for each of the plurality of UI elements from the translation component, wherein the first value includes one or more acronyms, abbreviations, words, phrases, or terms in the target language;
providing a request to a central server to retrieve at least one translation scenario, said at least one translation scenario comprising a second value for at least one of the plurality of UI elements, wherein the second value includes one or more acronyms, abbreviations, words, phrases, or terms in the target language;
receiving the second value for the at least one of the plurality of UI elements from the central server, wherein the second value is a previously customized value,
wherein the original value is in the source language and the first value and the second value are in the target language;
allowing a user to provide a third alternative value for each of the plurality of UI elements, wherein the third alternative value includes one or more acronyms, abbreviations, words, phrases, or terms in the target language, wherein providing the third alternative value further comprises typing into a form fillable field, into which the user can type text, symbols, or icons of the third alternative value;
allowing the user to independently select the original value, the first value, the second value, or the third value for each of the plurality of UI elements for display in the user interface; and
rendering the user interface with the selected values for each of the plurality of UI elements.

16. (canceled)

17. The method of claim 15, further comprising:
storing a selected combination of the original values, the first values, the second values and the third values as a first custom user scenario.

18. The method of claim 17, further comprising:
storing the first custom user scenario on the central server for access by a plurality of users.

19. The method of claim 15, wherein the translation component comprises a master translation database and a machine translation service, and wherein providing the request to the translation component comprises:
providing a first request to the master translation database and providing a second request to the machine translation service.

20. The method of claim 19, wherein the first request provides the first value for at least one UI element in the plurality of UI elements and wherein the second request provides the first value for at least one remaining UI element in the plurality of UI elements.

21. The non-transitory computer-readable media of claim 1, wherein the first value of at least one UI element of the plurality of UI elements received from the translation component is determined based on feedback corresponding to the at least one translation scenario comprising the previously customized second value.

22. The method of claim 15, wherein the first value of at least one UI element of the plurality of UI elements received from the translation component is determined based on feedback corresponding to the at least one translation scenario comprising the previously customized second value.
